(19) United States
(12) Patent Application Publication
(10) Pub. No.: US 2012/0194150 A1
(43) Pub. Date: Aug. 2, 2012

(54) SYSTEMS AND METHODS FOR LOW-BATTERY OPERATION CONTROL IN PORTABLE COMMUNICATION DEVICES

(75) Inventors: Jaejoon Chang, Duluth, GA (US); Ki Seok Yang, Atlanta, GA (US); Jeonghu Han, Atlanta, GA (US); Woonyun Kim, Johns Creek, GA (US); Chang-Ho Lee, Marietta, GA (US)

(73) Assignee: SAMSUNG ELECTRO-MECHANICS COMPANY, Gyunggi-Do (KR)

(21) Appl. No.: 13/018,788

(22) Filed: Feb. 1, 2011

(51) Int. Cl. G05F 1/575

(52) U.S. Cl. 323/281

(57) ABSTRACT

Systems and methods may include a low-dropout (LDO) voltage regulator for portable communication devices. The systems and methods may include a comparator having first and second inputs and generating a control voltage, the first input receiving a battery voltage from a battery source, the second input receiving a fixed voltage independent from the battery voltage, and a power management circuit that receives the control voltage and provides a regulated voltage based upon the control voltage, wherein when the received battery voltage is above the fixed voltage, the control voltage is provided at a high constant voltage, thereby resulting in the regulated voltage being at a first voltage, and wherein when the battery voltage is below the fixed voltage, the control voltage is provided at a low constant voltage, thereby resulting in the regulated voltage being at a second voltage less than the first voltage.

### FIELD OF INVENTION

Embodiments of the invention relate generally to battery operation control, and more particularly to the control of regulated power in a portable communication device.

### BACKGROUND OF THE INVENTION

With recent advances in a wide variety of mobile portable communication standards, there is an increased demand for wider usage of battery voltage in a mobile communication transmitter system in order to elongate the device operation time. In current battery-powered mobile communication transmitter devices, functional operation is guaranteed up to a certain point of battery voltage, below which the operational function is not even specified, or degraded performance is permitted until the operation is disrupted due to a malfunction of internal blocks such as a low drop out (LDO) regulator or other regulator. During a period of low-battery voltage operation, it is difficult to predict remaining operation time and likewise difficult to control the efficiency of device operation up to a point of certain battery voltage where even degraded performance operation is sustainable. In other words, the low-battery voltage region has been wasted; indeed, manufacturers do not design the internal functional circuit blocks to operate in the low-battery voltage region because of the randomness of regulated voltages that are powering the internal sub-blocks.

However, as increasing the usage time of electronic portable devices becomes more important, it may be necessary to control the region of low-battery voltage more accurately and efficiently. Thus, there is an opportunity for systems and methods for low-battery operation control in portable communication devices.

### SUMMARY OF THE INVENTION

In order to increase the efficiency of LDO designs for mobile communication devices, these designs may keep the output voltage of the LDO as high as possible during normal operation. However, as the battery voltage drops and gets close to the regulated voltage, the LDO driver block may start to drive the block output that is a gate voltage of the Power PMOS (p-channel metal-oxide-semiconductor) transistor as low as possible to maintain the LDO output voltage at a regulated voltage while driving Power PMOS transistor drain voltage up to a regulated voltage close to the battery voltage. This region of operation may be called the “Deep triode region operation”. Because the Power PMOS transistor is placed in the loop of LDO regulator, the characteristic of the Power PMOS transistor in the deep triode region significantly affects the characteristic of LDO regulator itself. The affected performance factors may be bandwidth and stability, and because of these degraded performance criteria, the performance under a certain voltage level of battery may not be guaranteed or even used, resulting in a shorter operation time for mobile communication devices. Accordingly, embodiments of the invention may provide systems and methods operable to variably change the output voltage of LDO regulator in such a way of keeping the Power PMOS transistor from operating in the deep triode region in order to lengthen the operation time of mobile communication devices in a more predicable manner.

In an example embodiment of the invention, there is a low-dropout (LDO) voltage regulator for a portable device. The LDO voltage regulator may include a first amplifier that receives a battery voltage from a battery source and generates a first output voltage; a second amplifier that receives the first output voltage of the first amplifier from the first amplifier, and outputs a control voltage; and a power management circuit that receives the control voltage and provides a regulated voltage based upon the control voltage. When the battery voltage is above a threshold voltage, the control voltage may remain substantially constant, thereby resulting in the regulated voltage being substantially constant. When the battery voltage drops below the threshold voltage, the control voltage may drop proportionally from the substantially constant regulated voltage, thereby resulting in a proportional drop in the regulated voltage from the substantially constant regulated voltage.

According to another example embodiment, there is a voltage regulator for a portable device. The voltage regulator may include a comparator having first and second inputs and generating a control voltage, the first input receiving a battery voltage from a battery source, the second input receiving a fixed voltage independent from the battery voltage, and a power management circuit that receives the control voltage and provides a regulated voltage based upon the control voltage. When the received battery voltage is above the fixed voltage, the control voltage may be provided at a high constant voltage, thereby resulting in the regulated voltage being at a first voltage. When the battery voltage is below the fixed voltage, the control voltage may be provided at a low constant voltage, thereby resulting in the regulated voltage being at a second voltage less than the first voltage.

### BRIEF DESCRIPTION OF THE DRAWINGS

Having thus described the invention in general terms, reference will be made now to the accompanying drawings, which are not necessarily drawn to scale, and wherein:

FIG. 1A illustrates an example control voltage generator that may be operative to control an example power management circuit such as an LDO/regulator, according to an example embodiment of the invention.

FIG. 1B illustrates how the example control voltage generator of FIG. 1A adjusts the outputted control voltage as a function of the battery voltage, according to an example embodiment of the invention.

FIG. 2A illustrates another example control voltage generator that may be operative to control an example power management circuit such as an LDO/regulator, according to an example embodiment of the invention.

FIG. 2B illustrates how the example control voltage generator of FIG. 2A adjusts the outputted control voltage as a function of the battery voltage, according to an example embodiment of the invention.

FIG. 3 illustrates an example power management circuit in accordance with an example embodiment of the invention.

### DETAILED DESCRIPTION OF THE INVENTION

Example embodiments of the invention will now be described more fully hereinafter with reference to the accompanying drawings, in which some, but not all, embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Embodiments of the invention may provide systems and methods for low-battery operation control in portable communication devices such as cellular phones, Blackberries, iPhones, tablet/laptop/netbook computers, and the like. The systems and methods may provide accurate control of regulated power in low-battery voltage situations to enable one or more of (1) predictable performance in low-battery voltage situations, (2) longer communication time with the given battery specification, and/or (3) efficiency enhancement at low-battery voltage operation.

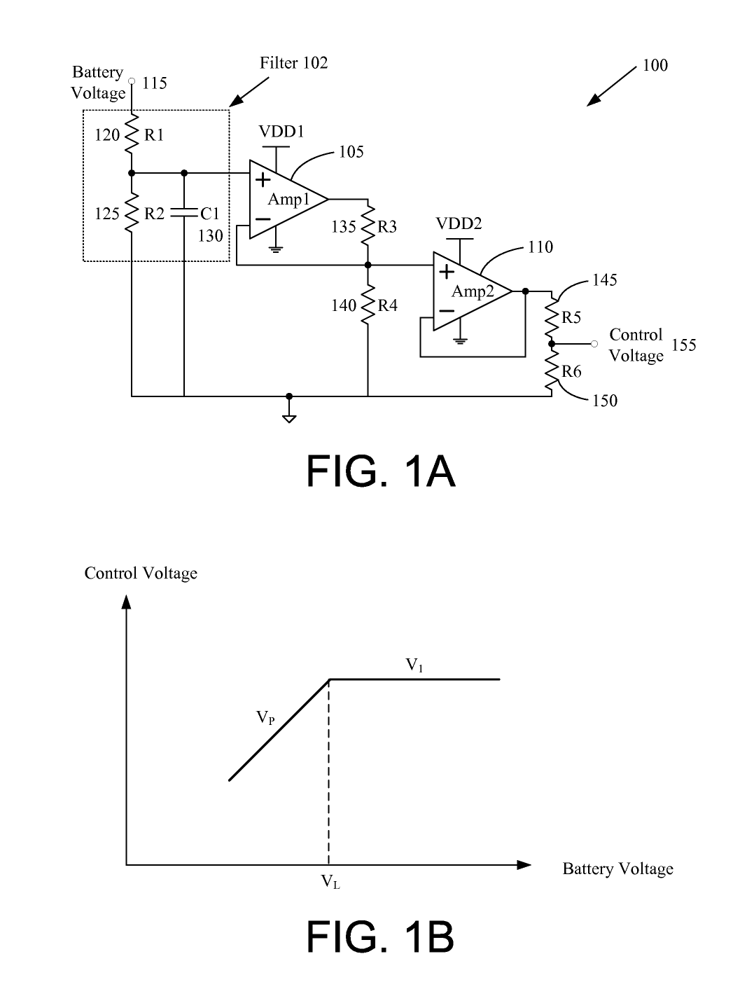

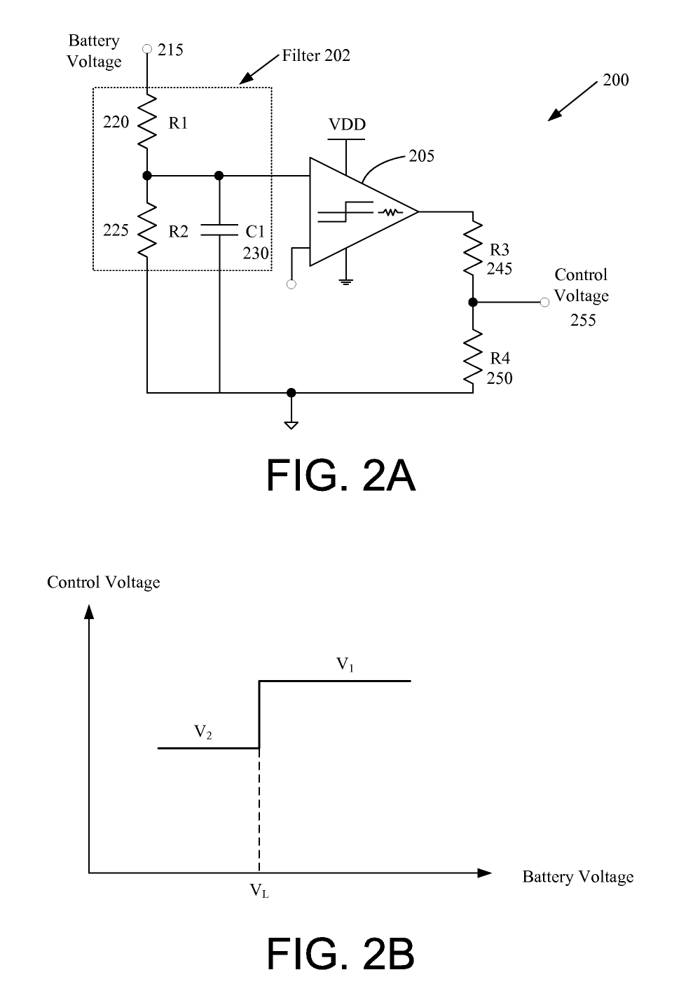

FIGS. 1A and 2A illustrate example control voltage generators that may be operative to control an example power management circuit such as an LDO/regulator, according to an example embodiment of the invention. It will be appreciated that the example control voltage generators may be an integrated part of the power management circuit, according to an example embodiment of the invention. Alternatively, the example control voltage generators may also be utilized with existing power management circuits without departing from example embodiments of the invention.

Turning now to FIG. 1A, the example control voltage generator 100 may include a filter 102, a first amplifier 105, a second amplifier 110, and resistors 135 (R3), 140 (R4), 145 (R5), and 150 (R6). The filter 102 may include resistors 120 (R1), 125 (R2), and capacitor 130 (C1), although various combinations of series/parallel resistors, capacitors, or inductors may be included in the filter 102, without departing from example embodiments of the invention. In FIG. 1A, the battery voltage 115 may be connected, via a filter 102, to a positive input port of the first amplifier 105. In particular, the battery voltage can be connected to a first port of resistor 120 (R1), and a second port of resistor 120 (R1) can be connected to the positive input port of the first amplifier 105. Likewise, a parallel configuration of a resistor 125 (R2) and capacitor 130 (C1) can be connected between (i) the node commonly connecting the second port of resistor 120 (R1) and the positive input port of the first amplifier 105, and (ii) ground (GND), according to an example embodiment of the invention. The filter 102 may be operative to filter out noise or supply ripples from the battery voltage 115 prior to delivery to the positive input port of the first amplifier 105.

The output from the output port of the first amplifier 105 can be connected to a first port of resistor 135 (R3), and the second port of the resistor 135 (R3) can be connected to the positive input port of the second amplifier 110. In addition, the second port of resistor 135 (R3) can also be connected to the negative input port of the first amplifier 105. As such, the output of the first amplifier is provided to the positive input port of the second amplifier 110, and fed back to the negative input port of the first amplifier 105, via resistor 135 (R3). A resistor 140 (R4) can be connected between (i) the node commonly connecting the negative input port of the first amplifier 105, the second port of resistor 135 (R3), and the positive input port of the second amplifier 110, and (ii) ground (GND), in order to further adjust the amount of voltage/current provided to the negative input port of the first amplifier 105 and the positive input port of the second amplifier 110. The output from the second amplifier 110 may be fed back to the negative input port of the second amplifier 110.

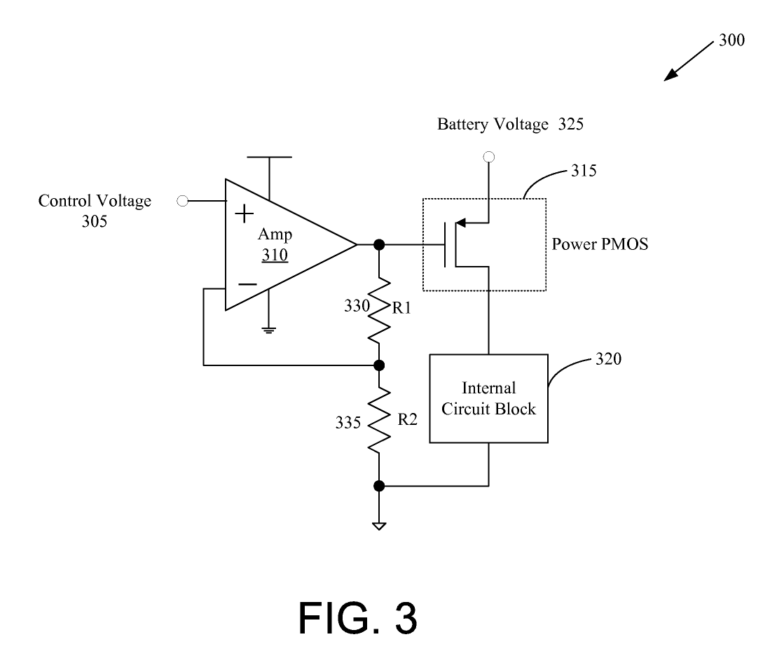

A series of resistors 145 (R5) and 150 (R6) can be connected between the output of the second amplifier 110 and ground, and a node between resistors 145 (R5) and 150 (R6) can be used to provide the control voltage 155, according to an example embodiment of the invention. The value of resistors 145 (R5) and 150 (R6) can be selected in order to ensure that the control voltage 155 is in the appropriate dynamic range for input to an example power management circuit such as an LDO/regulator. As will be described in further detail with respect to FIG. 3, the control voltage 155 can be used to control the power management circuit that provides an LDO/regulator output.

The operation of the example control voltage generator 100 of FIG. 1A will be discussed in conjunction with FIG. 1B, which illustrates the outputted control voltage 155 as a function of the battery voltage 115. The first amplifier 105 may be implemented as a limiting amplifier to provide a limited and fixed voltage when the battery voltage 115 is above a certain threshold value V_{L}, below which a power PMOS transistor of a power management circuit (LDO/regulator) may otherwise go into deep triode operation region without the adjustment of the control voltage 155 described herein. On the other hand, the first amplifier 105 may scale the output voltage proportionally or linearly downwards to a voltage V_{P}, as the battery voltage 115 drops below the threshold value V_{L}. Based upon the output of the first amplifier 105, the second amplifier 110 may generate a proportional control voltage 155 that is in the dynamic range of the input of the control power management circuit (LDO/regulator), which controls the output of the power management circuit.

Therefore, as shown in FIG. 1B, when the battery voltage 115 is above the threshold voltage V_{L}, the control voltage 155 remains substantially constant at a normal voltage level V₁. However, as the battery voltage drops below the threshold voltage V_{L}, the control voltage 155 is reduced proportionally or linearly to provide a voltage V_{P} that is predictable. Accordingly, when the battery voltage drops below the threshold voltage V_{L}, the control voltage 155 can likewise be reduced, thereby reducing an output voltage of the power management circuit (LDO/regulator) in order to maintain the voltage difference between the drain and source of the power PMOS transistor included with the power management circuit (LDO/regulator), as discussed in further detail with respect to FIG. 3. Even though the output voltage of the power management circuit may drop accordingly with the battery voltage 115 and the final performance of the system may be degraded, it may be predictable up to a battery voltage 115 level where the internal functioning block finally fails to work, thereby enabling the operation of mobile communication devices with degraded performance and widening the usable battery voltage range into the low-power region.

FIG. 2A illustrates another example control voltage generator 200 in accordance with an example embodiment of the invention. The control voltage generator 200 of FIG. 2A may differ in operation from the voltage generator 100 of FIG. 1A insofar as the output control voltage may be reduced in a stepwise manner to a lower, but substantially constant, voltage when the battery voltage drops below a threshold value, according to an example embodiment of the invention.

Turning now to FIG. 2A, the example control voltage generator 200 may include a filter 202, a comparator 205, and resistors 245 (R3), 250 (R4). The filter 202 may include resistors 220 (R1), 225 (R2), and capacitor 230 (C1), although various combinations of series/parallel resistors, capacitors, or inductors may be included in the filter 202, without departing from example embodiments of the invention. In FIG. 2A, the battery voltage 215 may be connected, via a filter 202, to a first input port of the comparator 205. In particular, the battery voltage can be connected to a first port of resistor 220 (R1), and a second port of resistor 220 (R1) can be connected to the positive input port of the comparator 205. Likewise, a parallel configuration of a resistor 225 (R2) and capacitor 230 (C1) can be connected between (i) the node commonly connecting the second port of resistor 120 (R1) and the positive input port of the first amplifier 105, and (ii) ground (GND), according to an example embodiment of the invention. The filter 202 may be operative to filter out noise or supply ripples from the battery voltage 215 prior to delivery to the positive input port of the comparator 205.

Still referring to FIG. 2A, the first input port of the comparator 205 can receive a linearly scaled down battery voltage 215 from filter 202, and the second input port of the comparator can receive an internally generated fixed voltage (e.g., from bandgap reference voltage) that is independent of, and not affected by, the battery voltage 215. Based upon the comparison of the two inputs, the comparator 205 can provide an output at its output port. A series of resistors 245 (R3) and 250 (R4) can be connected between the output of the comparator 205 and ground, and a node between resistors 245 (R3) and 250 (R4) can be used to provide the control voltage 255, according to an example embodiment of the invention. The value of resistors 245 (R3) and 250 (R4) can be selected in order to ensure that the control voltage 255 is in the appropriate dynamic range for input to an example power management circuit such as an LDO/regulator. As will be described in further detail with respect to FIG. 3, the control voltage 255 can be used to control the power management circuit that provides an LDO/regulator output.

The operation of the example control voltage generator 200 of FIG. 2A will be discussed in conjunction with FIG. 2B, which illustrates the outputted control voltage 255 as a function of the battery voltage 215. The comparator 205 may provide an output voltage at a first voltage level, thereby generating the control voltage 255 at a higher voltage level V₁ that is substantially constant, when the battery voltage 215 is greater than a threshold voltage V_{L}, below which a power PMOS transistor of a power management circuit (LDO/regulator) may otherwise go into a deep triode operation region without the adjustment of the control voltage 255 described herein. On the other hand, when the battery voltage 215 is less than the threshold voltage V_{L}, the comparator 205 may provide an output voltage at a second voltage level, thereby generating the control voltage 255 at a voltage level V₂ that is lower than the higher voltage level V₁, but that remains substantially constant for at least a portion of the battery voltage 215 range that is less than the threshold voltage V_{L}.

Therefore, as shown in FIG. 2B, when the battery voltage 215 is above the threshold voltage V_{L}, the control voltage 255 remains substantially constant at a normal voltage level V₁. However, when the battery voltage drops below the threshold voltage V_{L}, the control voltage 255 is reduced to a lower voltage level V₂, thereby reducing an output voltage of the power management circuit (LDO/regulator) in order to maintain the voltage difference between the drain and source of the power PMOS included with the control power management circuit (LDO/regulator), as discussed in further detail with respect to FIG. 3. The lower voltage level V₂ may be set to a minimum value needed to sustain a specified degraded performance of a mobile communication device, according to an example embodiment of the invention. Thus, the usable battery voltage range can be widened into the low-power region, according to an example embodiment of the invention.

FIG. 3 illustrates an example power management circuit 300 in accordance with an example embodiment of the invention. The example power management circuit 300 may include an amplifier 310, a power PMOS transistor 315, and internal circuit block 320, and resistors 330 (R1), 335 (R2). As configured, the positive input port of the amplifier 310 may receive a control voltage 305. It will be appreciated that the control voltage 305 may be received from an example control voltage generator (e.g., control voltage 155 or 255) described with respect to FIGS. 1A and 2A. The output of the amplifier 310 may be fed back to the negative input port of the amplifier 310 via a resistor 330 (R1). In particular, a first port of the first resistor 330 (R1) may be connected to the output of the amplifier 310, and a second port of the first resistor 330 (R1) may be connected to the negative input port of the amplifier 310. Likewise, a second resistor 335 (R2) may have a first port connected to the second port of the first resistor 330 (R1), and a second port connected to ground.

In addition, the output of the amplifier 310 may be connected to a gate of a power PMOS transistor 315. The source of the power PMOS transistor 315 may be connected to battery voltage 325. It will be appreciated that if the control voltage generators of FIGS. 1A and 2A are utilized, the battery voltage 325 may correspond to respective battery voltage 115 or 215, according to an example embodiment of the invention. The output of the amplifier 310 may control the operation of the power PMOS transistor 315 in providing a voltage via the drain to internal circuit block 320, which can include communications circuitry for a mobile communication device. The internal circuit block 320 can include mobile communications (TX, RX) components, including amplifiers. It will be appreciated that the output of the power management circuit 300 at the drain of power PMOS transistor 315 may have a linear relationship with the control voltage 305.

In an example embodiment, the internal circuit block 320 may include a complementary-metal-oxide-semiconductor (CMOS) power amplifier, perhaps in accordance with a mobile receiver or transmitter (e.g., a cellular application). In a CMOS mobile transmitter, for various reasons such as device protection and stable operation, the internal circuit block 320 may be powered by the power management circuit 300 (e.g., via the power PMOS transistor 315) at a cost of power efficiency. However, due to the voltage drop throughout the power management circuitry, including that associated with the control voltage generator, that is unavoidable, a certain amount of power is lost at the final power PMOS transistor 315. In order to minimize the power loss and maximize power efficiency of the system, the output voltage from the power management circuit 300 acting as an LDO/regulator may normally be set to the highest possible value somewhere below the battery voltage 325 even at the lowest possible battery voltage situation (e.g., as the name “Low Drop Out” (LDO) implies). From this mechanism of setting the lowest possible voltage of the battery, mobile communication device manufacturers may specify the minimum battery voltage for functional operation of the devices in the internal circuit block 320. In the voltage range below the minimum battery voltage, the functional operation may not be guaranteed.

It will be appreciated that the output of the power management circuit cannot be set to the battery voltage 325, according to an example embodiment of the invention. In particular, in order for the power PMOS transistor 315 employed in the power management circuit to work in saturation, the condition must be satisfied such that the voltage between the source and the drain must be greater than the value of the gate-to-source voltage (V_{gs}) minus the threshold voltage (V_{TH}) of the power PMOS transistor 315. However, to maximize the efficiency of the system, it may be unavoidable to operate the power PMOS transistor 315 in the triode region where the power PMOS transistor 315 itself works more like in linear operation. Even if the power PMOS transistor 315 goes into a triode region, most of performance criteria, including bandwidth and stability of a power management circuit 300 acting as an LDO or regulator, may be sustained. However, this maintained performance may be disrupted when the power PMOS transistor 315 goes into a deep triode operation region in which the source voltage driven by LDO/regulator driver (i.e., amplifier 310) is forced to be higher than or very close to the battery voltage 325 available at the moment.

It will be appreciated that when the battery voltage drops to the point of operation where the drain voltage (the LDO regulator output of amplifier 310) becomes very close or higher than the battery voltage, the drain-to-source voltage difference V_{ds} of Power PMOS transistor 315 becomes smaller while the gate-to-source voltage difference V_{gs} of Power PMOS transistor 315 becomes larger (this region of operation of transistor 315 may be called “Deep triode region” and the Power PMOS transistor 315 loses its saturated characteristic and operates more like a resistor with linear relationship between the voltage and the current). When the Power PMOS transistor 315 is being operated in the region of deep triode, the gain through the Power PMOS transistor 315 drops significantly and it may lose its capability of keeping stable operation over various environmental factors such as temperature and battery voltage.

To keep the power PMOS transistor 315 from being operated in the deep triode region, the control voltage generators illustrated in FIG. 1A or 2A can be utilized to reduce the control voltage 305 when the battery voltage 325 drops below a threshold voltage. Indeed, the control voltage 305 can be reduced or otherwise adjusted, if necessary, such that the power management circuit 300 is able to maintain the voltage difference (e.g., V_{gs}−V_{TH}) at the power PMOS transistor 315 to avoid operation in the deep triode region for at least a range of the battery voltage. Thus, it will be appreciated that the control voltage can be adjusted (e.g., reduced), if necessary, to maintain a minimum voltage difference between the drain and the source V_{ds} of power PMOS transistor 315 and keep the gate voltage of transistor 315 above a certain voltage level in which the power PMOS transistor 315 does not go into deep triode region of operation regardless of whether the battery voltage is above or below the threshold voltage for at least a range. Indeed, by keeping the gate voltage of transistor 315 above a certain voltage level, the drain and the source voltage difference V_{ds} of Power PMOS transistor 315 is maintained at a minimum voltage difference, and the gate and the source voltage V_{gs} difference of Power PMOS transistor 315 is reduced to avoid the deep triode region.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A low-dropout (LDO) voltage regulator for a portable device, comprising:
a first amplifier that receives a battery voltage from a battery source and generates a first output voltage;
a second amplifier that receives the first output voltage of the first amplifier from the first amplifier, and outputs a control voltage; and
a power management circuit that receives the control voltage and provides a regulated voltage based upon the control voltage,
wherein when the battery voltage is above a threshold voltage, the control voltage remains substantially constant, thereby resulting in the regulated voltage being substantially constant,
wherein when the battery voltage drops below the threshold voltage, the control voltage drops proportionally from the substantially constant regulated voltage, thereby resulting in a proportional drop in the regulated voltage from the substantially constant regulated voltage.

2. The LDO voltage regulator of claim 1, wherein the first amplifier includes a first positive input port, a first negative input port, and a first output port, and wherein the second amplifier includes a second positive input port, a second negative input port, and a second output port, wherein the first positive input port receives the battery voltage, wherein the first negative input port is connected to the second positive port, where the first output port further provides the first output voltage via a resistor to the second positive input port, and wherein the second output port is connected to the second negative input port.

3. The LDO voltage regulator of claim 1, wherein the battery voltage from the battery source is filtered or scaled prior to receipt by the first amplifier.

4. The LDO voltage regulator of claim 3, wherein battery voltage is filtered by at least one filter, wherein the at least one filter includes at least one resistor and at least one capacitor for filtering out noise or a supply ripple from the battery voltage from the battery source.

5. The LDO voltage regulator of claim 1, wherein the control voltage is obtained from a resistive network connected to an output of the second amplifier.

6. The LDO voltage regulator of claim 1, wherein the first amplifier is a limiting amplifier that provides a limited output voltage to provide a maximum LDO regulated output with highest possible efficiency during normal operation.

7. The LDO voltage regulator of claim 1, wherein the power management circuit includes a third amplifier, and a power PMOS transistor, wherein the third amplifier receives the control voltage and provides a third output voltage to a gate of the power PMOS transistor, wherein the regulated voltage is provided via the power PMOS transistor.

8. The LDO voltage regulator of claim 7, wherein a source of the power PMOS transistor is connected to the battery voltage from the battery source, and wherein a drain of the power PMOS transistor provides the regulated voltage.

9. The LDO voltage regulator of claim 8, wherein the third output voltage maintains a minimum voltage difference between a drain and source (V_{ds}) of power PMOS transistor and keeps a gate voltage of the power PMOS transistor above a voltage level such that the power PMOS transistor does not go into a deep triode region of operation regardless of whether the battery voltage is above or below the threshold voltage for at least a range.

10. The LDO voltage regulator of claim 7, wherein the third output voltage is obtained from a drain of a transistor of the third amplifier.

11. A voltage regulator for a portable device, comprising:
a comparator having first and second inputs and generating a control voltage, the first input receiving a battery voltage from a battery source, the second input receiving a fixed voltage independent from the battery voltage; and
a power management circuit that receives the control voltage and provides a regulated voltage based upon the control voltage,
wherein when the received battery voltage is above the fixed voltage, the control voltage is provided at a high constant voltage, thereby resulting in the regulated voltage being at a first voltage,
wherein when the battery voltage is below the fixed voltage, the control voltage is provided at a low constant voltage, thereby resulting in the regulated voltage being at a second voltage less than the first voltage.

12. The voltage regulator of claim 11, wherein the comparator includes a first input port for receiving the battery voltage, a second input port for receiving the fixed voltage, and an output port providing an output, wherein the control voltage is derived from the output via one or more resistors.

13. The voltage regulator of claim 11, wherein at least a first resistor and a second resistor are connected in series to the output port, wherein a node between the first resistor and the second resistor provides the control voltage.

14. The voltage regulator of claim 11, wherein the battery voltage from the battery source is filtered or scaled prior to receipt by the comparator.

15. The voltage regulator of claim 14, wherein the battery voltage is filtered by at least one filter, wherein the at least one filter includes at least one resistor and at least one capacitor for filtering out noise or a supply ripple from the battery voltage from the battery source.

16. The voltage regulator of claim 11, wherein the power management circuit includes an amplifier, and a power PMOS transistor, wherein the amplifier receives the control voltage and provides an output voltage to a gate of the power PMOS transistor, wherein the regulated voltage is provided via the power PMOS transistor.

17. The voltage regulator of claim 16, wherein a source of the power PMOS transistor is connected to the battery voltage from the battery source, and wherein a drain of the power PMOS transistor provides the regulated voltage.

18. The voltage regulator of claim 17, wherein the output voltage maintains a minimum voltage difference between a drain and source (V_{ds}) of the power PMOS transistor and keeps a gate voltage of the power PMOS transistor above a voltage level such that the power PMOS transistor does not go into a deep triode region of operation regardless of whether the battery voltage is above or below the threshold voltage for at least a range.

19. The voltage regulator of claim 17, wherein the drain of the power PMOS transistor is connected to internal circuitry of a mobile communication device.

20. The voltage regulator of claim 16, wherein the output voltage is obtained from a drain of a transistor of the amplifier.
